(19) United States
(12) Patent Application Publication
(10) Pub. No.: US 2011/0298846 A1
(43) Pub. Date: Dec. 8, 2011

(54) PLASMA DISPLAY PANEL AND DRIVE METHOD FOR PLASMA DISPLAY PANEL

(76) Inventor: Kei Kitatani, Osaka (JP)

(21) Appl. No.: 13/202,293

(22) PCT Filed: Mar. 29, 2009
(86) PCT No.: PCT/JP2010/002248

§ 371 Date: Aug. 18, 2011

(30) Foreign Application Priority Data
Mar. 31, 2009 (JP) 2009084554

(51) Int. Cl. G09G 3/28; G09G 5/10

(52) U.S. Cl. 345/690; 345/63

(57) ABSTRACT

A method for driving a plasma display panel includes a first mode for carrying out display by applying sustain pulses whose number corresponds to brightness weight of subfields; a second mode for carrying out display in which the one field period includes a smaller number of subfields than that of the first mode and the number of sustain pulses in the one field period is set to be more than that in the first mode; and a third mode for carrying out display in which an address time of a non-lighting line of the second mode is shortened and the shortened time is set in a sustain period. The first mode or the second mode is shifted to the third mode when a lighting rate is a predetermined value or less and a gradation of image is a predetermined value or more of each subfield.

### RELATED APPLICATIONS

This application is the U.S. National Phase under 35 U.S.C. §371 of International Application No. PCT/JP2010/002248, filed on Mar. 29, 2010, which in turn claims the benefit of Japanese Application No. 2009-084554, filed on Mar. 31, 2009, the disclosures of which Applications are incorporated by reference herein.

### TECHNICAL FIELD

The present invention relates to a plasma display panel and a method for driving a plasma display panel in which contrast of the plasma display panel is improved.

### BACKGROUND ART

A plasma display panel (hereinafter, also abbreviated as a “panel”) is a self-light-emitting type display device by discharging, which is characterized by having a large screen, thin size and light weight. As a method for displaying moving images having an intermediate gradation by using this panel, in general, a so-called subfield method is used. In the subfield method, one field period is divided into a plurality of binary images having predetermined brightness weights, respectively, and the images are superimposed in terms of time so as to display moving images.

In the subfield method, a drive method for a panel has been developed in which if an entire screen becomes dark, the entire screen is brightened by increasing the number of times of light emissions in the same rate, so that an image having high contrast can be expressed with dark atmosphere kept. Examples include a method in which as the average level of brightness of an image is lowered, the scale factor of weighting of the brightness of a binary image (hereinafter, referred to as “brightness scale factor”) is increased so as to increase the number of times of light emissions (see, for example, Patent Literature 1).

Conventionally, in order to increase contrast, the number of subfields is reduced, and address times are made to be the same without differentiating between a lighting line and a non-lighting line (see, for example, Patent Literature 2).

However, in conventional configurations, since the address times are made to be the same without differentiating between a lighting line and a non-lighting line, in order to increase the contrast from conventional methods, it is necessary to further reduce the number of subfields. When the number of subfields is reduced, display gradations are reduced as compared with conventional methods, and accordingly the display quality is deteriorated.

### CITATION LIST

### Patent Literature

Patent Literature 1: Japanese Patent Application Unexamined Publication No. H11-231833
Patent Literature 1: Japanese Patent Application Unexamined Publication No. 2006-308734

### SUMMARY OF THE INVENTION

A drive method for a plasma display panel of the present invention is a method for driving a plasma display panel having an image display region formed of a plurality of discharge cells for displaying an image in which one field period is composed of a plurality of subfields. The method for driving a plasma display panel includes a first mode, a second mode and a third mode. In the first mode, display is carried out by applying sustain pulses whose number corresponds to a brightness weight of each subfield. In the second mode, display is carried out in which one field period is composed of a smaller number of subfields than the number of subfields in the first mode and the number of sustain pulses to be applied in the one field period is set to be greater than the number of sustain pulses in the first mode. In the third mode, display is carried out in which an address time of a non-lighting line in the second mode is shortened and the shortened time of the address time is added to a sustain period.

In the method for driving a plasma display panel, the mode is shifted from the first mode or the second mode to the third mode when a lighting rate of the subfield is a first threshold value or less, a gradation of an image is a second threshold value or more, and a number of lighting lines in each subfield is a set number of lines or less.

With such a drive method, contrast in the plasma display panel can be improved.

Furthermore, the plasma display panel of the present invention is provided with a drive circuit for driving a plasma display panel including an image display region formed of a plurality of discharge cells for displaying an image, and one field period is composed of a plurality of subfields.

The drive circuit of the plasma display panel includes a first mode, a second mode and a third mode. In the first mode, display is carried out by applying sustain pulses whose number corresponds to a brightness weight of each subfield. In the second mode, display is carried out in which one field period is composed of a smaller number of subfields than the number of subfields in the first mode and the number of sustain pulses to be applied in the one field period is set to be greater than the number of sustain pulses in the first mode. In the third mode, display is carried out in which an address time of a non-lighting line in the second mode is shortened and the shortened time of the address time is added to a sustain period.

In the drive circuit of the plasma display panel, the mode is shifted from the first mode or the second mode to the third mode when a lighting rate of the subfield is a first threshold value or less, a gradation of an image is a second threshold value or more, and a number of lighting lines in each subfield is a set number of lines or less.

### BRIEF DESCRIPTION OF THE DRAWINGS

FIG. 1 is a perspective view showing a part of a plasma display panel in accordance with an exemplary embodiment of the present invention.

FIG. 2 is a diagram showing an arrangement of electrodes of the panel.

FIG. 3 is a circuit block diagram of a picture display device using the panel.

FIG. 4 shows driving waveforms applied to each electrode of the panel.

FIG. 5 shows configurations of subfields in one field period in a standard mode and in a peak brightness rising mode.

FIG. 6 is a flow chart for determining a drive mode of a panel.

FIG. 7 is a graph showing one example of a change over time of brightness of a panel in which an image is displayed in a peak brightness rising mode and before and after the period.

FIG. 8 shows configurations of subfields in one field period in a standard mode, a peak brightness rising mode, and a super peak brightness rising mode in accordance with an exemplary embodiment of the present invention.

FIG. 9 is a flow chart for determining a drive mode of a panel.

FIG. 10 is a graph showing a change over time of brightness of a panel in which an image is displayed in a super peak brightness rising mode and before and after the period.

FIG. 11 shows field change of the subfield structure when the super peak brightness rising mode starts.

### DETAILED DESCRIPTION OF THE PREFERRED EMBODIMENTS EXEMPLARY EMBODIMENT

Hereinafter, a plasma display panel and a drive method thereof in accordance with an exemplary embodiment of the present invention are described with reference to drawings.

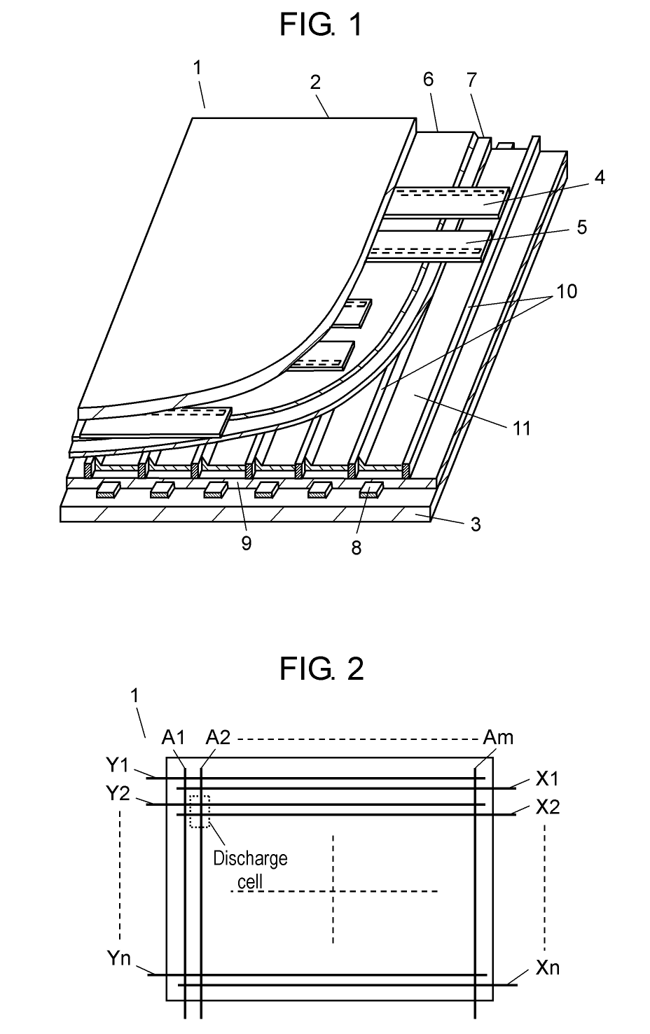

FIG. 1 is a perspective view showing a part of a panel structure in accordance with an exemplary embodiment of the present invention. Panel 1 includes front substrate 2 and rear substrate 3 that are made of glass and disposed to face each other. Front substrate 2 and rear substrate 3 are sealed to each other on the peripheral portions thereof and a discharge space is formed between the substrates. Front substrate 2 has a plurality of display electrode pairs each composed of scan electrode 4 and sustain electrode 5 formed in parallel to each other. Dielectric layer 6 is formed so as to cover scan electrode 4 and sustain electrode 5, and protective layer 7 is formed on dielectric layer 6. Furthermore, rear substrate 3 has a plurality of data electrodes 8, and insulator layer 9 is formed so as to cover data electrode 8. Furthermore, barrier ribs 10 are provided in parallel to data electrodes 8 on insulator layer 9 between data electrodes 8. Phosphor layers 11 are provided on insulator layer 9 between neighboring barrier ribs 10. Front substrate 2 and rear substrate 3 are disposed to face each other such that scan electrodes 4 and sustain electrodes 5 three-dimensionally intersect with data electrodes 8. Furthermore, the discharge space formed between front substrate 2 and rear substrate 3 is filled with a mixed gas of, for example, neon and xenon as a discharge gas. Note here that since scan electrodes 4 and sustain electrodes 5 are formed in parallel to each other, interelectrode capacitance is present between scan electrode 4 and sustain electrode 5.

FIG. 2 is a diagram showing an arrangement of electrodes of panel 1 in accordance with the exemplary embodiment of the present invention. In a row direction, n scan electrodes Y1 to Yn (scan electrodes 4 of FIG. 1) and n sustain electrodes X1 to Xn (sustain electrodes 5 of FIG. 1) are arranged alternately, and in a column direction, m data electrodes A1 to Am (data electrodes 8 of FIG. 1) are arranged. Herein, n and m are natural numbers. A discharge cell is formed where a pair of scan electrode Yi and sustain electrode Xi (i=1 to n) and one data electrode Aj (j=1 to m) are three-dimensionally intersected with each other. Accordingly, panel 1 has m×n discharge cells, and the discharge cells constitute an image display region of panel 1.

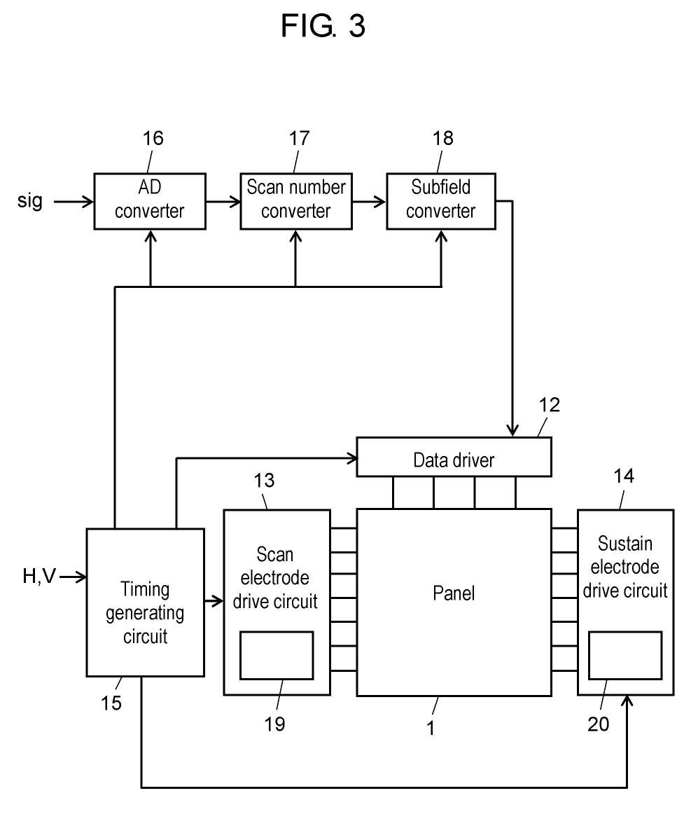

FIG. 3 is a circuit block diagram of an picture display device formed by using panel 1 in accordance with the exemplary embodiment of the present invention. The picture display device includes panel 1, data driver 12, scan electrode drive circuit 13, sustain electrode drive circuit 14, timing generating circuit 15, AD (analog-digital) converter 16, scan number converter 17, subfield converter 18 and a power circuit (not shown). A drive circuit of panel 1 includes at least data driver 12, scan electrode drive circuit 13, and sustain electrode drive circuit 14.

A picture signal sig is converted into picture data as a digital signal by AD converter 16, and the picture data are output to scan number converter 17. Scan number converter 17 converts the picture data into the picture data corresponding to the number of pixels of panel 1, and output the data to subfield converter 18. Subfield converter 18 divides the picture data of each pixel into a plurality of bits corresponding to a plurality of subfields, and outputs picture data for each subfield to data driver 12. Data driver 12 converts the picture data for each subfield into a signal corresponding to each of data electrodes A1 to Am so as to drive each of data electrode A1 to Am.

Furthermore, horizontal synchronizing signal H and vertical synchronizing signal V are input into timing generating circuit 15. Timing generating circuit 15 generates various timing signals based on horizontal synchronizing signal H and vertical synchronizing signal V, and supplies the timing signals to each circuit block. Scan electrode drive circuit 13 supplies a drive voltage waveform to scan electrodes Y1 to Yn based on the timing signal, and sustain electrode drive circuit 14 supplies a drive voltage waveform to sustain electrodes X1 to Xn based on the timing signals. Herein, scan electrode drive circuit 13 has sustain pulse generator 19 for generating a sustain pulse mentioned below, and sustain electrode drive circuit 14 also has sustain pulse generator 20. In order to collect electric power accompanied by charge and discharge of interelectrode capacitance between scan electrode 4 and sustain electrode 5, sustain pulse generators 19 and 20 are provided with a power-collection portion including an LC resonance circuit.

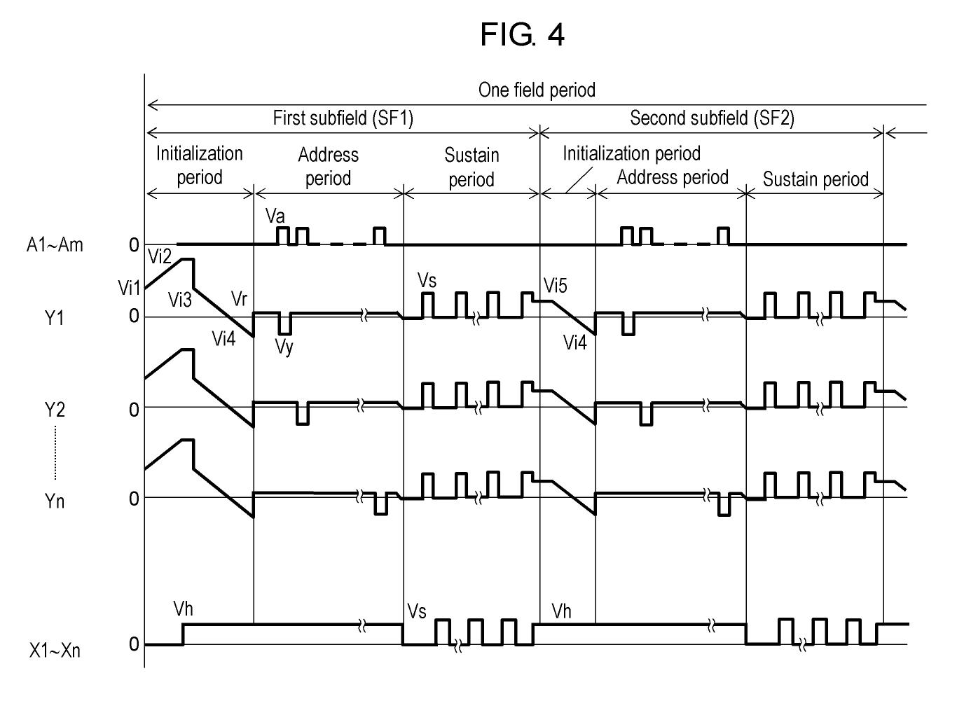

Next, a driving waveform for driving panel 1 and an operation of panel 1 by the driving waveform are described. FIG. 4 shows driving waveforms to be applied to each electrode of panel 1 in accordance with the exemplary embodiment of the present invention. One field period includes a plurality of (for example, ten) subfields SF1 to SF 10, and each of subfields SF1 to SF 10 has weighting of brightness (brightness weights) of 1, 2, 3, 6, 11, 18, 30, 44, 60, and 80. In this way, one field period is structured by arranging subfields so that the later subfield in one filed period has a larger brightness weight. However, the number of subfields in one field period and the brightness weight of each subfield are not limited to the above-mentioned values. Each subfield includes an initialization period in which an electric charge state of discharge cells is initialized, an address period in which address discharge for selecting a discharge cell to be displayed is carried out, and a sustain period in which sustain discharge is carried out in the discharge cell selected in the address period.

In the initialization period of first subfield SF1, data electrodes A1 to Am and sustain electrodes X1 to Xn are kept at 0 (V), and a ramp voltage gradually rising from voltage Vi1 (V) not higher than a discharge-starting voltage with respect to sustain electrodes X1 to Xn toward voltage Vi2 (V) exceeding the discharge-starting voltage is applied to scan electrodes Y1 to Yn. This causes first feeble initializing discharge in all the discharge cells. Thus, negative wall voltage accumulates on scan electrodes Y1 to Yn, and positive wall voltage accumulates on sustain electrodes X1 to Xn and data electrodes A1 to Am. Herein, the wall voltage on electrodes indicates a voltage generated by wall electric charge that has accumulated on dielectric layer 6 or phosphor layers 11 covering the electrodes. Thereafter, while sustain electrodes X1 to Xn are kept at positive voltage Vh (V), and a ramp voltage gradually falling from voltage V13 (V) to voltage V14 (V) is applied to scan electrodes Y1 to Yn. This operation causes a second feeble initializing discharge in all the discharge cells. Then, the wall voltage on scan electrodes Y1 to Yn and the wall voltage on sustain electrodes X1 to Xn are weakened, and the wall voltage on data electrodes A1 to Am is adjusted to a value suitable for address operation in the address period.

In the address period subsequent to the initialization period, scan electrodes Y1 to Yn are kept at Vr (V) once. Next, positive address pulse voltage Va (V) is applied to data electrode Ak (k=1 to m) of a discharge cell to be displayed in the first row among data electrodes A1 to Am, and scan pulse voltage Vy (V) is applied to the first row of scan electrode Y1. At this time, a voltage of the intersection between data electrode Ak and scan electrode Y1 is addition of the wall voltage on data electrode Ak and the wall voltage on scan electrode Y1 to an externally applied voltage (Va−Vy) (V), which exceeds the discharge-starting voltage. This causes address discharge between data electrode Ak and scan electrode Y1 as well as between sustain electrode X1 and scan electrode Y1. As a result, in the discharge cell, the positive wall voltage accumulates on scan electrode Y1, the negative wall voltage accumulates on sustain electrode X1, and the negative wall voltage accumulates also on data electrode Ak. In this way, the address operation of carrying out address discharge in a discharge cell to be displayed in the first row and accumulating wall voltage on the respective electrodes is carried out. On the other hand, voltages at intersections of data electrodes to which positive address pulse voltage Va (V) is not applied and scan electrode Y1 do not exceed the discharge-starting voltage, and therefore no address discharge occurs. The above-described address operation is sequentially carried out until the discharge cell in the n-th row of the discharge cells. Thus, the address period is completed.

In the sustain period subsequent to the address period, firstly, sustain electrodes X1 to Xn are reset to 0 (V), and positive sustain pulse voltage Vs (V) is applied to scan electrodes Y1 to Yn. At this time, in the discharge cells in which address discharge has occurred, the voltage across scan electrode Yi and sustain electrode Xi is addition of the wall voltage on scan electrode Yi and the wall voltage on sustain electrode Xi to sustain pulse voltage Vs (V), which exceeds the discharge-starting voltage. This causes sustain discharge between scan electrode Yi and sustain electrode Xi. As a result, negative wall voltage accumulates on scan electrode Yi, and positive wall voltage accumulates on sustain electrode Xi. At this time, positive wall voltage accumulates on data electrode Ak as well. In the discharge cells in which no address discharge has occurred in the address period, no sustain discharge occurs, and the state of the wall voltage at the time of completion of the initialization period is maintained. Subsequently, scan electrodes Y1 to Yn are reset to 0 (V), and positive sustain pulse voltage Vs (V) is applied to sustain electrodes X1 to Xn. In the discharge cells in which a sustain discharge has occurred, the voltage across sustain electrode Xi and scan electrode Yi exceeds the discharge-starting voltage. This causes sustain discharge between sustain electrode Xi and scan electrode Yi again. Consequently, negative wall voltage accumulates on sustain electrode Xi, and positive wall voltage accumulates on scan electrode Yi. In the same way since then, sustain pulses whose number corresponds to the brightness weight are applied alternately to scan electrodes Y1 to Yn and sustain electrodes X1 to Xn, and thereby, sustain discharge can be continued in discharge cells in which address discharge has occurred in the address period. At the end of the sustain period, by applying a so-called thin pulse across scan electrodes Y1 to Yn and sustain electrodes X1 to Xn, the wall voltage on scan electrodes Y1 to Yn and on sustain electrodes X1 to Xn are erased while leaving the positive wall voltage on data electrode Ak. Thus, the sustain operation in the sustain period is completed.

In the initialization period of second subfield SF2, sustain electrodes X1 to Xn are kept at voltage Vh (V), data electrodes A1 to Am are kept at 0 (V), and a ramp voltage gradually falling from voltage V15 (V) to voltage V14 (V) is applied to scan electrodes Y1 to Yn. While the ramp voltage is falling, in the discharge cells in which sustain discharge has occurred in an immediately preceding sustain period (the sustain period of SF1), feeble discharge occurs and thereby the wall charge formed on each electrode is weakened, and a voltage in the discharge cells becomes near the state of the discharge-starting voltage. On the other hand, in the discharge cells in which address discharge and sustain discharge have not occurred in SF1, feeble discharge does not occur in the initialization period of SF2, and the state of the wall charge at the time of completion of the initialization period of SF1 is maintained.

With respect to the address period and the sustain period in SF2, by applying waveforms similar to those in SF1, sustain discharge is allowed to occur in the discharge cell corresponding to a picture signal. Furthermore, in SF3 to SF10, by applying driving waveforms similar to those in SF2 to each electrode, picture display is carried out.

Next, the brightness weight, the brightness scale factor and the number of sustain pulses are described. The number of sustain pulses to be applied in each subfield is a value obtained by multiplying a brightness weight of the subfield by a brightness scale factor. The sustain pulses whose number is the thus obtained value are applied to scan electrodes Y1 to Yn and sustain electrodes X1 to Xn, respectively. One field period is 1/60 sec=16.7 ms. Depending upon the specification of panel 1, when one field period is composed of, for example, ten subfields SF1 to SF10 whose brightness weight is 1, 2, 3, 6, 11, 18, 30, 44, 60, and 80, respectively, as mentioned above, the brightness scale factors become 1 to 5 due to the limitation of drive time. For example, when the brightness scale factor is 5, the number of sustain pulses in each subfield is 5, 10, 15, 30, 55, 90, 150, 220, 300, or 400, and the number of sustain pulses to be applied to one field period is 1275. That is to say, in one field period, the number of sustain pulses to be applied to scan electrodes Y1 to Yn is 1275, and similarly, the number of sustain pulses to be applied to sustain electrodes X1 to Xn is 1275.

Herein, for example, when the brightness scale factor is 1, the number of sustain pulses to be applied in one field period is 255, which means that there is allowance in the drive time as compared with the case where the brightness scale factor is 5. Therefore, when the brightness scale factor is 1, the brightness weight of each subfield may be changed such that the number of subfields is, for example, 12 and the total of the brightness weight is 255. In this way, the number of subfields constituting one field period and the brightness weight of each subfield may be appropriately changed according to the brightness scale factor. Furthermore, the value of the brightness scale factor is not limited to an integer and may include numbers of decimal places. The product of the brightness weight and the brightness scale factor, which is represented by an integer, may be a value of the number of sustain pulses to be applied in the subfield. When the product of the brightness weight and the brightness scale factor includes numbers of decimal places, the value may be made into an integer by omitting, rounding up, or rounding off the numbers of decimal places. Note here that the case where panel 1 is driven by setting a subfield configuration and a brightness scale factor as mentioned above is defined as a standard mode, that is, a first mode. In this way, the first mode is a mode in which one field period is composed of a plurality of subfields, and display is carried out by applying sustain pulses whose number corresponds to a brightness weight of each subfield.

In a conventional drive method for a panel, as the average level of brightness of an image is lowered, a brightness scale factor is increased so as to increase the number of light emissions, thus making the entire screen bright. Furthermore, according to the increase in the number of light emissions, the number of subfields can be appropriately reduced, and thus the drive time for increasing the number of light emissions is secured. However, when the number of subfields is reduced more than necessary, a pseudo contour may occur, thus deteriorating the display quality. Since it is necessary to set the number of subfields in order not to generate such deterioration of the display quality, when the average level of brightness is a predetermined value (for example, 30%) or less, the number of subfields and the brightness scale factor are constant, that is, the number of light emissions is constant. Note here that the above-mentioned standard mode is the same as that in such a conventional drive method.

On the contrary, in order to improve the brightness, when a display area of an image is small and the gradation of the image is high, the number of light emissions may be increased by further reducing the number of subfields and by using the allowance drive time. Thus, when the average level of the brightness of an image is low, display with higher brightness than in conventional drive methods can be carried out. That is to say, in general, panel 1 is driven in the above-mentioned standard mode. However, when a display area of an image is small and the gradation of the image is high, panel 1 is driven in a peak brightness rising mode, that is, in a second mode, in which one field period is composed of a smaller number of subfields than that in the standard mode, and a larger number of sustain pulses is applied in one field period as compared with the number of sustain pulses in one field period in the standard mode.

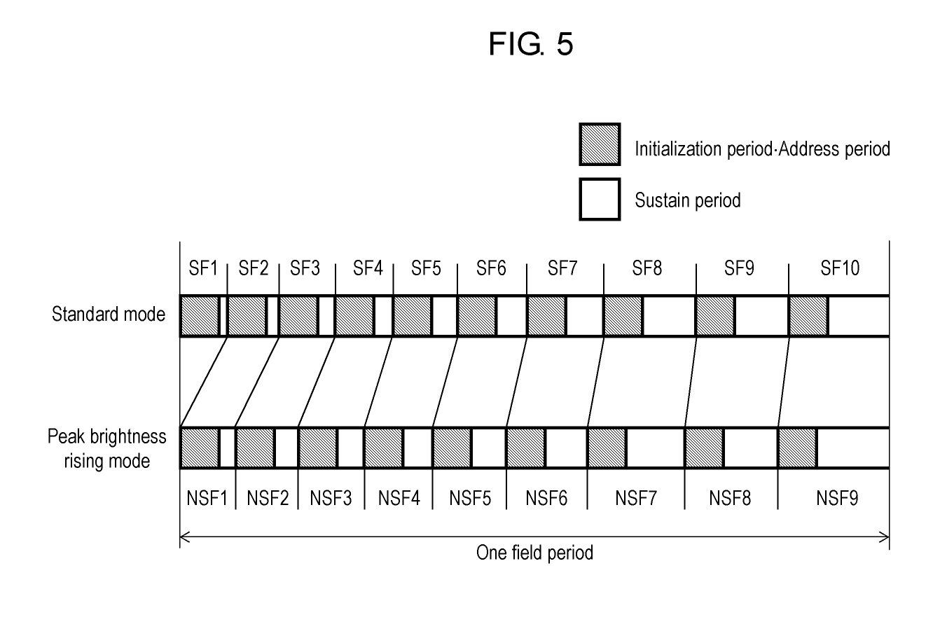

FIG. 5 shows subfield structures in one field period in the standard mode and the peak brightness rising mode, respectively. In FIG. 5, hatched portions show the initialization period and the address period together, and white portions show the sustain period. Each of subfields SF1 to SF10 in the standard mode has a brightness weight of 1, 2, 3, 6, 11, 18, 30, 44, 60, or 80.

As shown in FIG. 5, in the peak brightness rising mode, by deleting subfield SF1 with a minimum gradation in the standard mode, one field period is composed of nine subfields SF2 to SF10. Herein, these subfields are referred to as subfields NSF1 to NSF9 as shown in FIG. 5. In subfields NSF1 to NSF9, a driving waveform to be applied to each electrode is the same as that to be applied to each electrode in subfields SF2 to SF10. The driving waveforms to be applied to scan electrode 4, sustain electrode 5 and data electrode 8 in the initialization period of subfield NSF1 are the same as the driving waveforms to be applied to the electrodes in subfield SF1.

Furthermore, the number of sustain pulses to be applied in one field period in the peak brightness rising mode is greater than that in the standard mode. Each of subfields NSF1 to NSF9 has a brightness weight of 2, 3, 6, 11, 18, 30, 44, 60, or 80. Furthermore, when the brightness scale factor is made to be, for example, 6 that is greater than 5, a maximum value in the standard mode, the number of sustain pulses of subfields NSF1 to NSF9 are 12, 18, 36, 66, 108, 180, 264, 360, and 480, respectively.

That is to say, in the peak brightness rising mode, the number of sustain pulses in one field period is 1524, which is more than 1275 in the standard mode. Therefore, as compared with the case of the standard mode, the peak brightness can be increased. Note here that the value of the brightness scale factor is not limited to an integer and may include numbers of decimal places. The product of the brightness weight and the brightness scale factor, which is represented by an integer, may be a value of the number of sustain pulses to be applied in the subfield. When the product of the brightness weight and the brightness scale factor includes numbers of decimal places, the value may be made into an integer by omitting, rounding up, or rounding off the numbers of decimal places.

Herein, in the peak brightness rising mode, subfield SF1 with the minimum gradation (1 gradation), which is used in the standard mode, is deleted. Therefore, since it is not possible to display gradations (1, 4, 7, 10, 12, 15, 19 gradations, . . . ), in which SF1 is required to be lighted up for displaying, the display quality is deteriorated. Therefore, when an image including a wide range of gradations from a low gradation to a high gradation is to be displayed in the peak brightness rising mode, many gradations cannot be displayed. Consequently, the display quality is deteriorated as compared with the case in which display is carried out in the standard mode. Thus, the peak brightness rising mode is a mode in which a gradation that cannot be displayed is included in the gradations between the minimum displayable gradation and the maximum displayable gradation.

In this exemplary embodiment, subfield SF1 is deleted in the peak brightness rising mode. However, a subfield to be deleted is not limited to SF1 and a subfield with a minimum gradation is deleted. That is to say, depending upon how brightness weights of subfields SF1 to SF10 are set, a subfield to be deleted varies. Furthermore, a subfield to be deleted may not be necessarily limited to a subfield with a minimum gradation, but a subfield with a larger gradation may be deleted. At this time, a next larger gradation with respect to the minimum gradation is deleted. When a subfield is further deleted, a subfield for driving a next larger gradation is deleted. In this way, the corresponding subfield is deleted subsequently from a subfield with a smaller gradation. In this case, in the peak brightness rising mode, larger number of gradations that cannot be displayed are included in gradations between a minimum displayable gradation and a maximum displayable gradation. However, display can be carried out by applying a larger number of sustain pulses in one field period as compared with the number of sustain pulses in one field period in the standard mode. Therefore, display can be carried out with the peak brightness further increased.

Next, an example of conditions when display is carried out in the peak brightness rising mode is described. When the number of discharge cells constituting an image display region is NT (=m×n), and the number of discharge cells in which sustain discharge is carried out in the z-th subfield (z=1 to 10) is Nz, the ratio rz=Nz/NT is defined as a lighting rate of the z-th subfield. When the lighting rates of all subfields SF1 to SF10 (hereinafter, also referred to as “rz”) are a first threshold value (hereinafter, also referred to as “rd”), for example, 5% or less, it is determined that an image area is small. Furthermore, the gradation of an image (hereinafter, also referred to as “G”) is a second threshold value (hereinafter, also referred to as “Gd”), for example, 200 gradation or more, it is determined that the number of gradation of an image is high. The number Nz of the discharge cells or gradation G of an image in which sustain discharge is carried out in the z-th subfield can be obtained by using picture data obtained by converting, for example, picture signal sig by AD converter 16.

Note here that the above-mentioned values of rd and Gd may be appropriately set according to the property of panel 1 so that a desired display quality can be obtained. Furthermore, when rz=0 is satisfied, there is no discharge cell in which an image is displayed, it is not necessary to carry out display in the peak brightness rising mode. Therefore, when 0<rz≦rd and Gd≦G≦Gmax are satisfied, display is carried out in the peak brightness rising mode. Herein, Gmax is a maximum value of the displayable gradation. When the displayable gradation is 0 to 255, Gmax is 255.

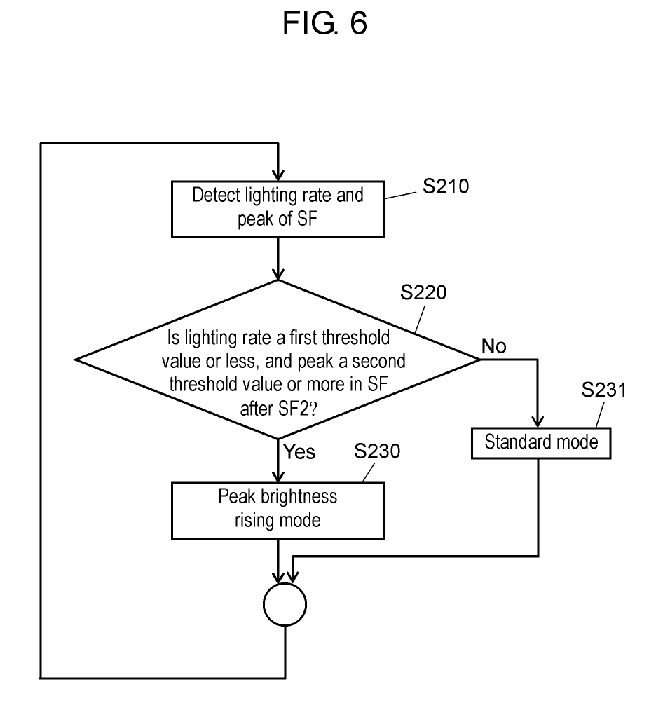

FIG. 6 is a flow chart for determining a drive mode of panel 1. The lighting rate and the peak of subfields (hereinafter, also abbreviated as “SFs”) are detected (step S210), and it is confirmed whether or not the lighting rates of SFs after SF2 are the first threshold value or less and the peak is the second threshold value or more (step S220). When the conditions are satisfied (“Yes” in step S220), the drive mode of panel 1 is determined to be a peak brightness rising mode (step S230). Then, the procedure is returned to step S210.

When the SFs do not satisfy this condition (“No” in step S220), the drive mode of panel 1 is determined to be a standard mode (step S231). Then, the procedure is returned to step S210.

In this way, the flow for determining the drive mode of panel 1 repeats the above-mentioned steps.

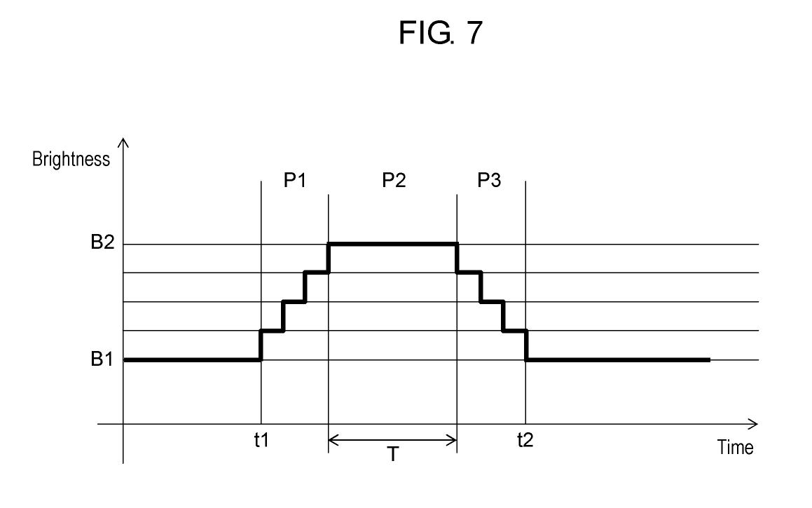

Furthermore, when the number of subfields and the brightness scale factor are changed by shifting the drive mode from the standard mode to the peak brightness rising mode, they are changed stepwise. In other words, a period of each change state in the stepwise change is controlled. FIG. 7 shows one example of change over time of brightness of panel 1 in a period in which display is carried out in the peak brightness rising mode and periods before and after the period. FIG. 7 shows that display is carried out in the standard mode firstly, the mode is shifted to the peak brightness rising mode from the state of normal peak brightness B1 at time t1, and then the mode is shifted to the standard mode at time t2. In period P1 starting from time t1, that is, in the period at the beginning of the peak brightness rising mode, the number of sustain pulses is increased stepwise, and thereby increasing the brightness stepwise, and the brightness reaches peak brightness B2 that is higher than normal peak brightness B1. In the subsequent period P2, peak brightness B2 is sustained for predetermined time T. In subsequent period P3, that is, in the period at the end of the peak brightness rising mode, on the contrary to period P1, the number of sustain pulses is reduced stepwise, thereby reducing the brightness stepwise. Herein, in order to change the number of sustain pulses, the brightness scale factor is changed. Thus, in period P1, period P2 and period P3, display is carried out in the peak brightness rising mode, and after period P3 (after time t2), display is carried out in the standard mode. The reason why the brightness is changed stepwise in periods P1 and P3 is because the change in the brightness is made to be inconspicuous. For example, the brightness is changed every one second and the change rate of the brightness at that time is made to be 3% to 4%, thereby enabling peak brightness to be increased with the change of the brightness unrecognized. Furthermore, by limiting the time in which display is carried out in the peak brightness rising mode (time period from time t1 to time t2) to a third predetermined time (for example, 20 sec to 30 sec) or less, it is possible to suppress the reduction in reliability due to temperature rise of the drive circuit.

In this exemplary embodiment, in order to achieve further increase in peak brightness, a scan line that has lighted up in one field before is detected, and when the number of lighting lines is predetermined number of lines or less, and the condition becomes the above-mentioned conditions in which the mode is shifted to the peak brightness rising mode, address is carried out in an address time per one line in only a lighting scan line. Then, in the non-lighting scan line, scanning is carried out in a minimum cycle in which latch of shift resister of a scanning driver is possible. Thus, total address time in one field is reduced. As a result, an allowance drive time is added to the sustain period, a super peak brightness rising mode, that is, a third mode is achieved in which the brightness is further increased as compared with the above-mentioned second mode.

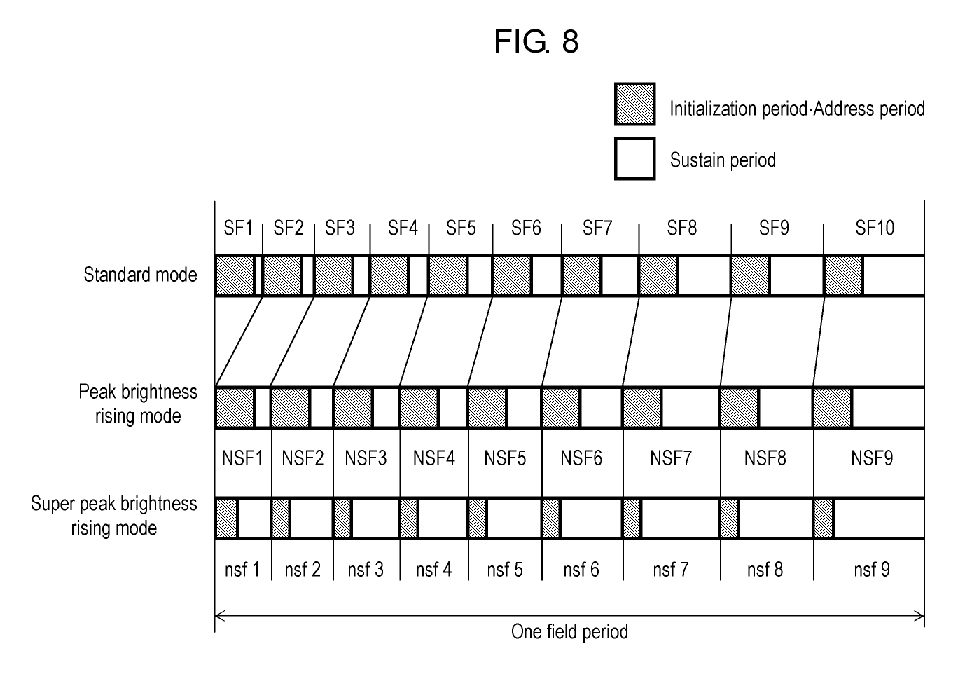

FIG. 8 shows configurations of subfields in one field period in a standard mode, a peak brightness rising mode, and a super peak brightness rising mode, respectively, in accordance with an exemplary embodiment of the present invention. In the super peak brightness rising mode in this exemplary embodiment, the number of gradations is made to be the same as that in the peak brightness rising mode, in other words, the brightness can be increased in which the number of subfields is made to be the same as that in the peak brightness rising mode. The initialization, address, and sustain periods in one field in one field period in the subfield configurations in the standard mode, the peak brightness rising mode and the super peak brightness rising mode in this exemplary embodiment are shown in FIG. 8. As shown in FIG. 8, in the super peak brightness rising mode as the third mode, display is carried out in a state in which an address time of the non-lighting lines of the peak brightness rising mode as the second mode is shortened, and the shortened time is added to the sustain period. The number of the sustain pulses to be applied in one field period in the super peak brightness rising mode is more than that in the standard mode. Each of subfields nsf1 to nsf9 in the super peak brightness rising mode has a brightness weight of 2, 3, 6, 11, 18, 30, 44, 60, or 80. Furthermore, a region in which the scan line in the super peak brightness rising mode is lighted up is ⅕ of total number of lines, the address cycle per one line of the lighting lines is 1 μs, the address cycle in the non-lighting line is 50 ns, and the time per sustain pulse is 5 μs. In the above-mentioned conditions, the brightness rising rate in the super peak brightness rising mode is represented by the following mathematical formula 1 when it is converted in HDTV (High Definition Television) in which the number of scan lines is 1080.

$$Conventional address time = ( 1080 lines \times 1.0 μ s \times 9 SF ) = 9720 μs \\ Address time of the present invention = \{ ( 1080 \times 1 / 5 \times 1.0 μs ) + ( 1080 \times 4 / 5 \times 0.05 μs ) \} \times 9 SF = 2332.8 μs \\ Allowance time = 9720 μs - 2332.8 μs = 7387.2 μs \\ Increase of sustain pulses = 7387.2 μs \div 5 μs = 1477.4 pulses \qquad [ Math . 1 ]$$

From the mathematical formula 1, in the super peak brightness rising mode, the number of sustain pulses in one field period is 3001, which is more by 1477 than that in the peak brightness rising mode (1524). Therefore, the brightness can be increased to 1.96 times as compared with that in the peak brightness rising mode. Assignment of the sustain pulses to SFs may be the same as in the peak brightness rising mode.

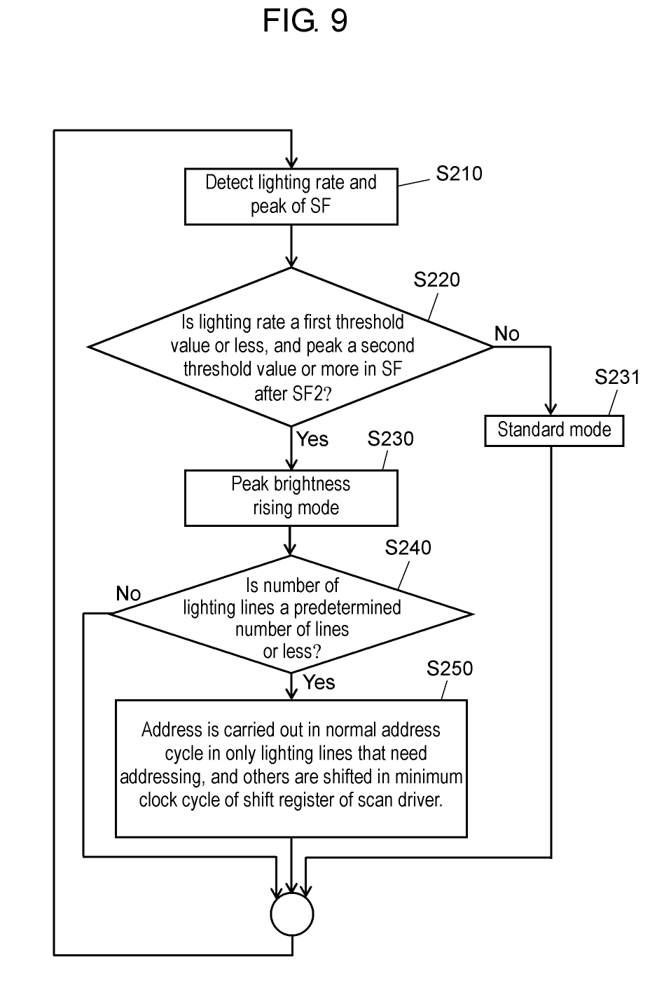

FIG. 9 is a flow chart for determining a drive mode of panel 1. The lighting rate and the peak of SF are detected (step S210), and it is confirmed whether or not the lighting rates are the first threshold value or less and the peaks are the second threshold value or more in SFs after SF2 (step S220). When the conditions are satisfied (“Yes” in step S220), the drive mode of the panel is determined to be the peak brightness rising mode (step S230). Then, it is confirmed whether or not the number of lighting lines is a predetermined number of lines or less (step S240). As mentioned above, in a region in which the scan lines light up, the predetermined number of lines is made to be ⅕ with respect to the total number of lines. When the lighting line is the predetermined number of lines or less (“Yes” in step S240), the drive mode of the panel is shifted to the super peak brightness rising mode. That is to say, address is carried out in a normal address cycle in only the lighting lines that need addressing, and others are shifted in a minimum clock cycle of a shift register of a scan driver (step S250). Then, the procedure is returned to step S210.

On the other hand, in step S220, when the conditions are not satisfied (“No”), the drive mode of the panel is determined to be the standard mode (step S231). Then, the procedure is returned to step S210. Furthermore, in step S240, when the number of lighting lines is not the predetermined number of lines or less (“No”), the procedure is returned to step S210.

In this way, the flow for determining the drive mode of panel 1 repeats the above-mentioned steps.

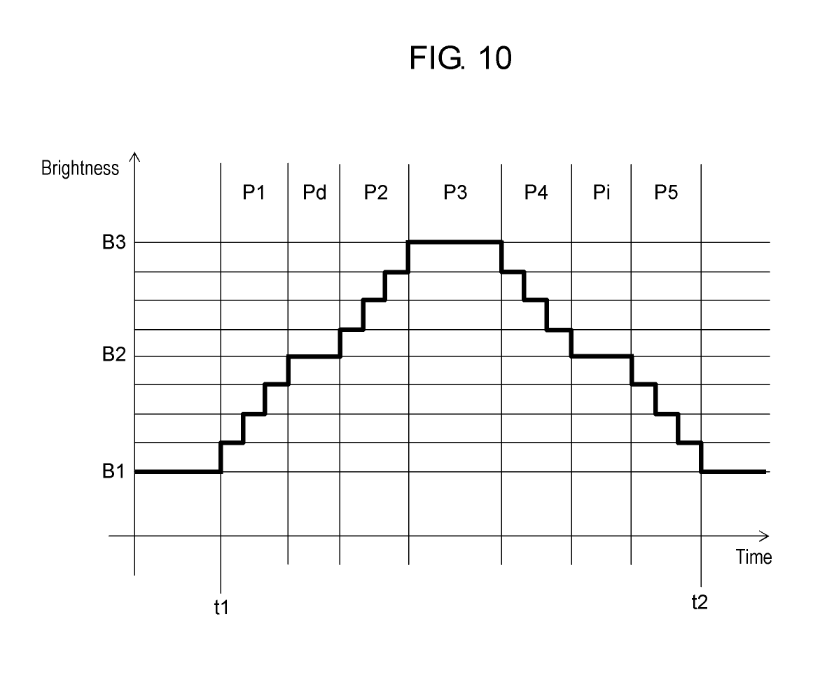

Next, a period in which the drive mode of panel 1 is made to be the super peak brightness rising mode, and then returned to the standard mode is described. Firstly, the drive mode is shifted from the standard mode to the peak brightness rising mode, and then the drive mode is shifted to the super peak brightness rising mode. When the number of subfields or the brightness scale factor is changed, the time control is carried out. Then, the drive mode is shifted from the super peak brightness rising mode to the peak brightness rising mode, and returned to the standard mode. FIG. 10 shows change over time of the brightness of panel 1 in a period in which display is carried out in the peak brightness rising mode and periods before and after the period. As mentioned above, in period P1 starting from time t1, that is, in the period at the beginning of the peak brightness rising mode, by increasing the number of sustain pulses stepwise, the brightness is increased stepwise, and thereby, the brightness reaches peak brightness B2 that is higher than peak brightness B1 in the normal mode. When the drive mode is shifted from the second mode to the third mode in this way, at the time of the peak brightness in the second mode, an address period is shortened by spending a first predetermined period of time (period P1).

In subsequent period Pd, the number of lighting scan lines is detected, and when the number is a threshold value or less, the address time of the non-lighting line is gradually reduced. In subsequent period P2, by increasing the number of sustain pulses stepwise, the brightness is increased stepwise. In period P2, the brightness in the super peak brightness rising mode reaches peak brightness B3 that is higher than peak brightness B2 in the peak brightness rising mode. Then, the super peak brightness rising mode is maintained by spending third predetermined time P3. That is to say, in this exemplary embodiment, the time in which the drive mode is the third mode is limited to the third predetermined time or less.

In subsequent period P4, that is, in the period at the end of the super peak brightness rising mode, on the contrary to period P2, by reducing the number of sustain pulses stepwise, the brightness is reduced stepwise. Herein, in order to change the number of sustain pulses, the brightness scale factor is changed. Thereafter, in Pi period, on the contrary to Pd period, the address period is extended by spending time Pi, and returned to the original address time. Then, in P5 period, on the contrary to P1 period, the brightness scale factor is reduced stepwise so that the brightness reaches brightness B1. The reason why the address cycle is gradually changed in periods Pd and Pi is because the change in the brightness due to the rapid change of the center of gravity of light emission of the sustain pulse is made to be inconspicuous. Specifically, for example, the address cycle of lines that do not need lighting is reduced from the first subfield for each one field by 0.1 μs to 0.2 μs. In the subsequent field, the second subfield is reduced by 0.1 μs to 0.2 μs. In the subsequent field, the third subfield is reduced by 0.1 μs to 0.2 μs. The address time is gradually reduced in this way. As mentioned above, in this exemplary embodiment, when the mode is shifted from third mode to the first mode or to the second mode, the number of sustain pulses in the third mode is reduced stepwise so as to reduce the brightness to the peak brightness of the second mode, and the address time is extended by spending the second predetermined time (Pi period).

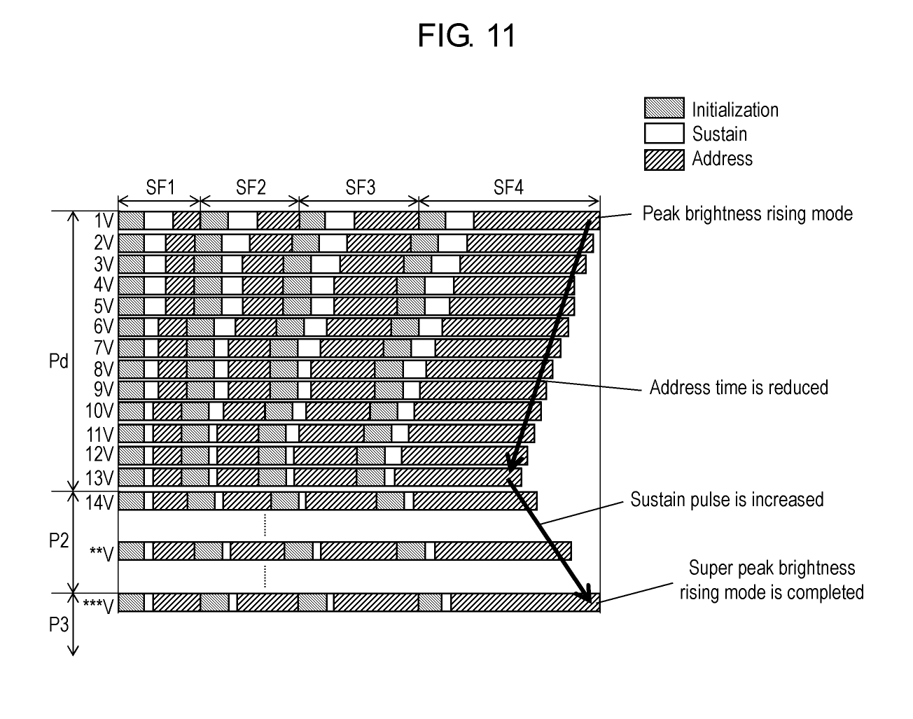

The reason why the brightness is reduced stepwise in periods P1, P2, P4 and P5 is because the change of the brightness is made to be inconspicuous. Specifically, for example, the brightness is changed every one second, and the change rate of brightness at that time is made to be 3% to 4%. As a result, the peak brightness can be increased in such a manner that the change in the brightness is not recognized. FIG. 11 shows the change of field in the subfield structure when the super peak brightness rising mode starts. FIG. 11 shows, as an example, changes over time by the change of the field in the initialization, address, and sustain periods in which the brightness is increased. The second mode is assumed to be an initialization state, and the address time is gradually reduced over, for example, 13 TV fields as mentioned above (Pd period). The address time is reduced to a target address time, and then the sustain pulse is increased stepwise (P2 period). Thereafter, the state becomes a third mode stationary state (P3 period).

Furthermore, by limiting the time (P3 period) in which display is carried out in the peak brightness rising mode to a predetermined time (for example, 20 sec to 30 sec) or less, it is possible to suppress the reduction in reliability due to the temperature rise in a drive circuit.

In this exemplary embodiment, in the peak brightness rising mode, it is not necessary to limit only the minimum gradation, gradation including gradations larger than the minimum gradation may be deleted. In this way, the corresponding subfield is deleted subsequently from a subfield with a smaller gradation. In this case, in the peak brightness rising mode, larger number of gradations that cannot be displayed are included in gradations between a minimum displayable gradation and a maximum displayable gradation. However, display can be carried out by applying a larger number of sustain pulses in one field period as compared with the number of sustain pulses in one field period in the standard mode. Therefore, display can be carried out with the peak brightness further increased.

Then, when the mode is shifted from the peak brightness rising mode in which display is carried out by deleting a subfield for driving a plurality of gradations including the minimum gradation to the above-mentioned super peak brightness rising mode, the peak brightness can be further increased. In this case, gradation expression is trade off with respect to deterioration, but as the display area of an image is smaller, such a display method is effective.

As mentioned above, in this exemplary embodiment, when an image display area is small and when the number of gradations of the image is high, display is carried out in the peak brightness rising mode. When the number of lighting lines is a predetermined number of lines or less, by carrying out the super peak brightness rising mode, gradation expression is hardly deteriorated, and the peak brightness can be increased. As a result, for example, twinkling of stars in a scene of the starry sky in the darkness is clearer, an image of more beautiful starry sky can be achieved.

### INDUSTRIAL APPLICABILITY

As mentioned above, a method for driving a plasma display panel in accordance with the present invention can increase peak brightness of a panel without deteriorating the display quality, and is useful for an picture display device.

### REFERENCE MARKS IN THE DRAWINGS

1 panel
4 scan electrode
5 sustain electrode
8 data electrode
13 scan electrode drive circuit
14 sustain electrode drive circuit
19, 20 sustain pulse generator

1. A method for driving a plasma display panel having an image display region formed of a plurality of discharge cells for displaying an image, in which one field period is composed of a plurality of subfields,
the method comprising:
a first mode for carrying out display by applying sustain pulses whose number corresponds to a brightness weight of each subfield;
a second mode for carrying out display in which the one field period is composed of a smaller number of subfields than a number of subfields in the first mode and a number of sustain pulses to be applied in the one field period is set to be greater than the number of sustain pulses in the first mode; and
a third mode for carrying out display in which an address time of a non-lighting line in the second mode is shortened and the shortened time of the address time is added to a sustain period,
wherein the mode is shifted from the first mode or the second mode to the third mode when a lighting rate of a subfield is a first threshold value or less, a gradation of an image is a second threshold value or more, and a number of lighting lines in each subfield is a set number of lines or less.

2. The method for driving a plasma display panel according to claim 1,
wherein when the mode is shifted from the second mode to the third mode, the address period is shortened by spending a first predetermined time at a peak brightness time of the second mode.

3. The method for driving a plasma display panel according to claim 1,
wherein when the mode is shifted from the third mode to the first mode or the second mode, the number of sustain pulses in the third mode is reduced stepwise so that brightness is reduced to peak brightness in the second mode, and
an address time is extended by spending a second predetermined time.

4. The method for driving a plasma display panel according to claim 1,
wherein a time in which the mode is the third mode is limited to a third predetermined time or less.

5. A plasma display panel comprising a drive circuit for driving the plasma display panel that comprises an image display region formed of a plurality of discharge cells for displaying an image, in which one field period is composed of a plurality of subfields,
the drive circuit of the plasma display panel comprising:
a first mode for carrying out display by applying sustain pulses whose number corresponds to a brightness weight of each subfield;
a second mode for carrying out display in which the one field period is composed of a smaller number of subfields than a number of subfields in the first mode and a number of sustain pulses to be applied in the one field period is set to be greater than the number of sustain pulses in the first mode; and
a third mode for carrying out display in which an address time of a non-lighting line in the second mode is shortened and the shortened time of the address time is added to a sustain period,
wherein the mode is shifted from the first mode or the second mode to the third mode when a lighting rate of a subfield is a first threshold value or less, a gradation of an image is a second threshold value or more, and a number of lighting lines in each subfield is a set number of lines or less.

6. The plasma display panel according to claim 5,
wherein when the mode is shifted from the second mode to the third mode, the address period is shortened by spending a first predetermined time at a peak brightness time of the second mode.

7. The plasma display panel according to claim 5,
wherein when the mode is shifted from the third mode to the first mode or the second mode, the number of sustain pulses in the third mode is reduced stepwise so that brightness is reduced to peak brightness in the second mode, and
an address time is extended by spending a second predetermined time.

8. The plasma display panel according to claim 5,
wherein a time in which the mode is the third mode is limited to a third predetermined time or less.

9. The method for driving a plasma display panel according to claim 2,
wherein when the mode is shifted from the third mode to the first mode or the second mode, the number of sustain pulses in the third mode is reduced stepwise so that brightness is reduced to peak brightness in the second mode, and
an address time is extended by spending a second predetermined time.

10. The method for driving a plasma display panel according to claim 2,
wherein a time in which the mode is the third mode is limited to a third predetermined time or less.

11. The plasma display panel according to claim 6,
wherein when the mode is shifted from the third mode to the first mode or the second mode, the number of sustain pulses in the third mode is reduced stepwise so that brightness is reduced to peak brightness in the second mode, and
an address time is extended by spending a second predetermined time.

12. The plasma display panel according to claim 6,
wherein a time in which the mode is the third mode is limited to a third predetermined time or less.
